(19) United States
(12) Patent Application Publication
(10) Pub. No.: US 2005/0249381 A1
(43) Pub. Date: Nov. 10, 2005

(54) Image capture device to provide security, video capture, ambient light sensing, and power management

(76) Inventors: Kelan C. Silvester, Portland, OR (US); Aaron M. Tsirkel, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/840,994

(22) Filed: May 7, 2004

(51) Int. Cl. G06K 9/00

(52) U.S. Cl. 382/115; 340/5.53; 713/186

(57) ABSTRACT

An image capture device for providing security, power management, and video capture to a computer system is described. Specifically, the image capture device is capable of capturing fingerprint and facial images. If the captured images matches previously enrolled images, a user is granted access to a computer system. After a user is granted access to the computer system, the image capture device monitors the ambient lighting of the computing environment and adjusts the display settings accordingly.

### FIELD OF THE INVENTION

The present invention pertains to the field of computer system design. More particularly, the present invention relates to a single camera that captures face and fingerprint images to provide user authentication. Further, the camera monitors ambient lighting, provides power management, and captures video.

### BACKGROUND OF THE INVENTION

Biometrics is the statistical study of biological phenomena. A person's individual features may be defined using biometrics. Possible biometrics for identifying a person include DNA, fingerprint, facial features, odor, gait, height, handwriting, and speech.

Once a person's biometric has been recorded, a subsequent measurement of the person's features may be used to provide security. For example, a security system may grant access to a building only if the person's speech is authenticated. Speech authentication typically compares the frequencies of syllables of a spoken word against a previously recorded version of the word.

### BRIEF DESCRIPTION OF THE DRAWINGS

FIG. 1 is an embodiment of a computer system that uses an electronic device having an image sensor to protect against unauthorized access to a host computer;

FIG. 2A is a side view of an embodiment of an image capture device used to capture fingerprint images and facial images, and to monitor ambient light of a computing environment;

FIG. 2B is a front view of an embodiment of an image capture device used to capture fingerprint images and facial images, and to monitor ambient light of a computing environment;

FIG. 3 is a flowchart of an embodiment for using an image capture device to provide user access to a computer system;

FIG. 4 is a flowchart of another embodiment for using an image capture device to provide user access to a computer system; and

FIG. 5 is a flowchart of an embodiment for using an image capture device to provide user authentication and to monitor ambient lighting of a computing environment.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

A computer system or a computer network may have confidential applications and data stored in the system's memory or on a mass storage device. To prevent unauthorized access, most computer systems only require the user to provide a username and a password. The username and password is then matched against a database of authorized usernames with corresponding passwords. Thus, a person who wishes to steal confidential information from a computer system would only need the owner's username and password to gain access. A variety of unscrupulous methods exist to steal or alter the username and password for malicious intent. Additional levels of protection would help to prevent theft of confidential information of a computer system.

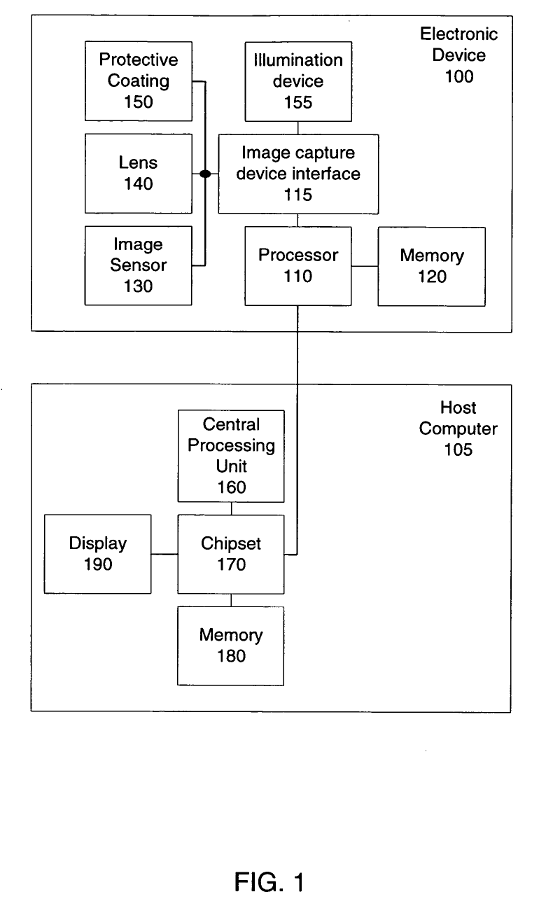

FIG. 1 depicts one embodiment of the invention for providing an additional level of protection to a computer system. Electronic device 100 is coupled to host computer 105. Electronic device 100 comprises a processor 110, an image capture device interface 115, memory 120, an image sensor 130, a lens 140, a protective coating 150, and an illumination device 155. The processor 110 is coupled to memory 120 and image capture device interface 115. The image capture device interface is coupled to image sensor 130, lens 140, protective coating 150, and illumination device 155.

Host computer 105 comprises a central processing unit (CPU) 160, chipset 170, memory 180, and display 190. The CPU 160 is coupled to chipset 170. Chipset 170 is coupled memory 180 and display 190. The chipset 170 of host computer 105 is also coupled to processor 110 of electronic device 100. This connection between host computer 105 and electronic device 100 may be made through a universal serial bus (USB).

The electronic device 100 comprises an image capture device or a camera. A facial image or a fingerprint image is captured through the image sensor 130. The focus assembly or lens 140 is adjusted depending on whether a facial image or a fingerprint image is being captured. To capture a facial image, the lens 140 is focused for long range. In contrast, the lens 140 is focused for close or immediate range to capture a fingerprint image. An image may be brought into focus by a mechanical movement of the lens 140 or through software executed by processor 110.

The image capture device interface 115 is a circuit that enables communication between processor 110 and image sensor 130, lens 140, protective coating 150, and illumination device 155. The protective coating 150 protects the lens 140 from debris and other foreign substances that may degrade the quality of an image captured by the image sensor 130. The protective coating 150 may comprise a plastic plate. Alternatively, the protective coating 150 may comprise a mechanical shutter that closes when a fingerprint image is being captured and opens when a facial image is being captured. For example, the mechanical shutter may close as a finger comes within a one-inch distance from the lens 140. The illumination device 155 provides a light source to help capture a fingerprint image.

The image sensor 130 may be a charge-coupled device (CCD) or a complementary metal oxide semiconductor (CMOS). The image sensor 130 may separate the spectrum of color captured in an image into red, green, and blue for digital processing by the processor 110. The processor 110 may extract a digital template from the image captured by the image sensor 130. The processor may store the extracted digital template in memory 120. The memory 120 may also be used to store a previously enrolled image of a fingerprint image or a facial image, or both.

The extracted digital template may then be used to provide user authentication to the host computer 105. The authentication may be performed by processor 100 of electronic device 100 or by CPU 160 of host computer 105. If user authentication is performed by the host computer 105, previously enrolled fingerprint and facial images may be stored in memory 180. The extracted digital template is transmitted from processor 110 to chipset 170. The CPU 160 obtains data from chipset 170 and compares the extracted digital template to previously enrolled images obtained from memory 180. Embodiments of the authentication procedure will be described in further detail below.

Aside from user authentication, the electronic device 100 may be used to provide power management for host computer 105. The host computer 105 may be placed in a low power mode unless the electronic device 100 detects a facial image, a fingerprint image, or is able to detect a user's presence. For example, the display 190 of host computer 105 may be turned off if the electronic device 100 does not detect a facial image or a fingerprint image. The electronic device 100 may be given its own power source. The host computer may be switched to a lower power mode or turned completely off. If the electronic device 100 detects the presence of a user, the electronic device 100 may send a signal to the host computer 105 to place the host computer 105 in full-power mode. By simply detecting a face or a fingerprint, the electronic device 100 may drive an algorithm to turn on or off portions of the host computer 105 in order to save power and promote battery life.

Moreover, if electronic device 100 wakes host processor 105 from a low power mode, the image sensor 130 may measure the amount of ambient light that is available to the computing environment of host computer 105. The processor 110 or CPU 160 may compare the detected ambient lighting with the desired display settings stored in memory 120 or memory 180. If the detected ambient lighting does not match that of the desired display settings, the processor 110 or the CPU 160 may adjust the colors of the display 190 of the host computer 105. The processor 110 or the CPU 160 may also adjust the backlight of the display 190 to accommodate the ambient lighting of the computing environment.

In addition, the electronic device 100 may be used for general purpose video capturing. For example, the electronic device 100 may capture streaming digital video. Further, the electronic device 100 may capture digital still images.

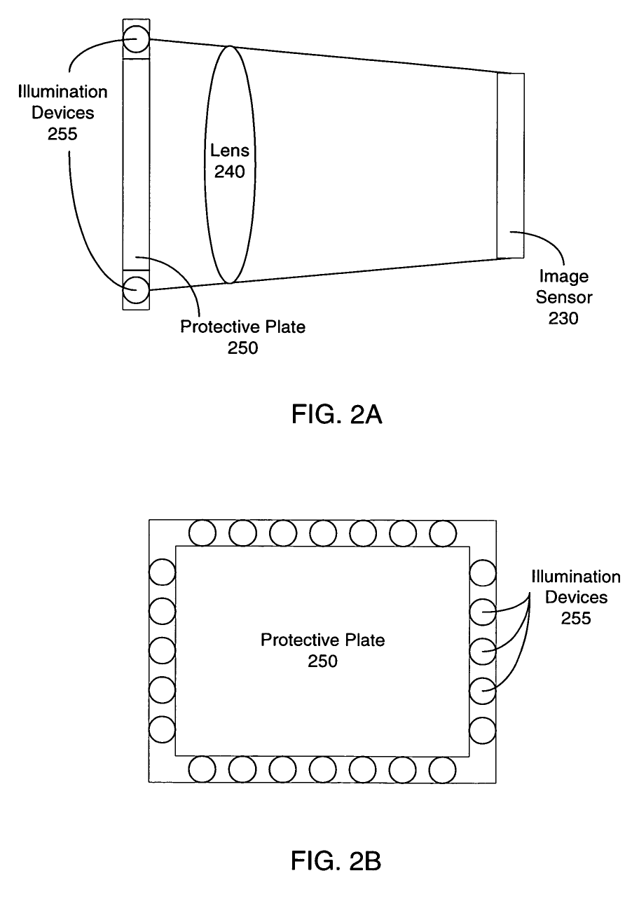

FIG. 2A depicts a side view of an embodiment of an image capture device. The image capture device of FIG. 2A may be part of the electronic device 100 described above in FIG. 1. The image capture device of FIG. 2A comprises an image sensor 230, a lens 240, a protective plate 250, and a plurality of illumination devices 255. The image sensor 230 is coupled to lens 240. Lens 240 is coupled to protective plate 250. Protective plate 250 is coupled to illumination devices 255.

The illumination devices 255 may be light-emitting diodes. The illumination devices 255 are enabled if a finger touches or makes contact with the protective plate. When enabled, the illumination devices 255 provide a light to illuminate a fingertip. This helps the lens 240 to focus on the finger, such that the ridges, valleys, and other minutia characteristics of a fingerprint are determinable. The image sensor 230 then captures an image of the fingerprint.

The illumination devices 255 may be disabled when the image capture device is capturing a facial image or when a finger is not detected within a very close range. Moreover, the illumination devices 255 may be disabled when the image capture device is sensing the ambient lighting of a computing environment.

FIG. 2B depicts an embodiment of the front view of the image capture device of FIG. 2A. The protective plate 250 is surrounded along its perimeter by a plurality of illumination devices 255. Although a plurality of illumination devices 255 is shown, the image capture device is not limited to having a plurality of illumination devices 255. Alternatively, the image capture device may comprise a single illumination device.

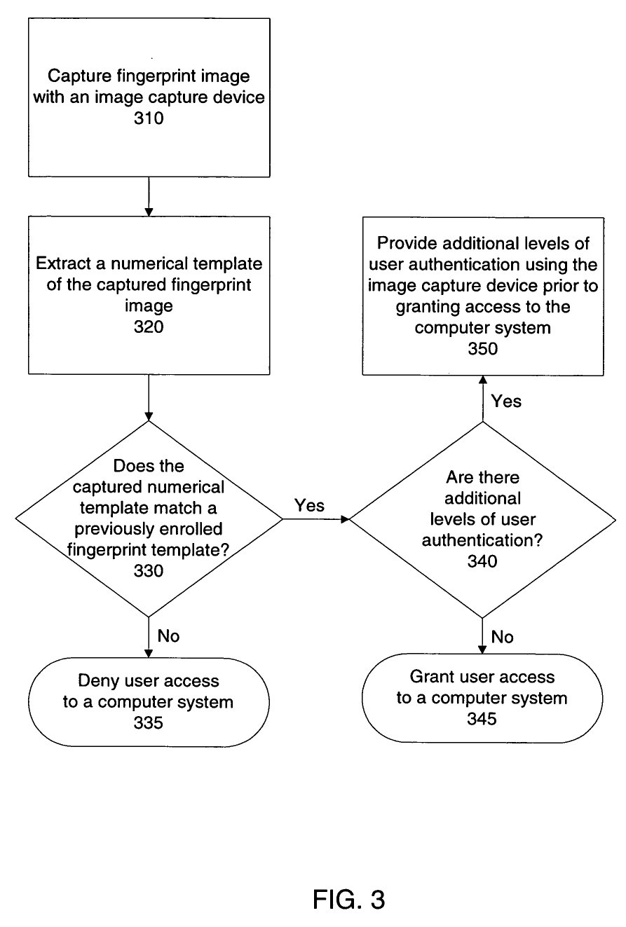

FIG. 3 is a flowchart of an embodiment for using an image capture device to provide user access to a computer system. A fingerprint image is captured with an image capture device in operation 310. A numerical or digital template of the captured fingerprint image is extracted in operation 320. The numerical template extraction may be performed by algorithms running on a processor of the computer system or by algorithms running on a processor of an electronic device coupled to the computer system. If the extracted numerical template does not match a previously enrolled fingerprint template in operation 330, the user is denied access to the computer system in operation 335.

On the other hand, if the captured numerical template matches a previously enrolled fingerprint template in operation 330, the computer system may check defined configuration parameters to determine if additional levels of user authentication are available and required in operation 340 before granting user access. If additional levels of user authentication are not required in operation 340, the user is granted access to the computer system in operation 345. However, if additional levels of user authentication are required in operation 345, algorithms to implement the authentication are executed in operation 350. The authentication of operation 350 is performed through the same image capture device as used in capturing the fingerprint image.

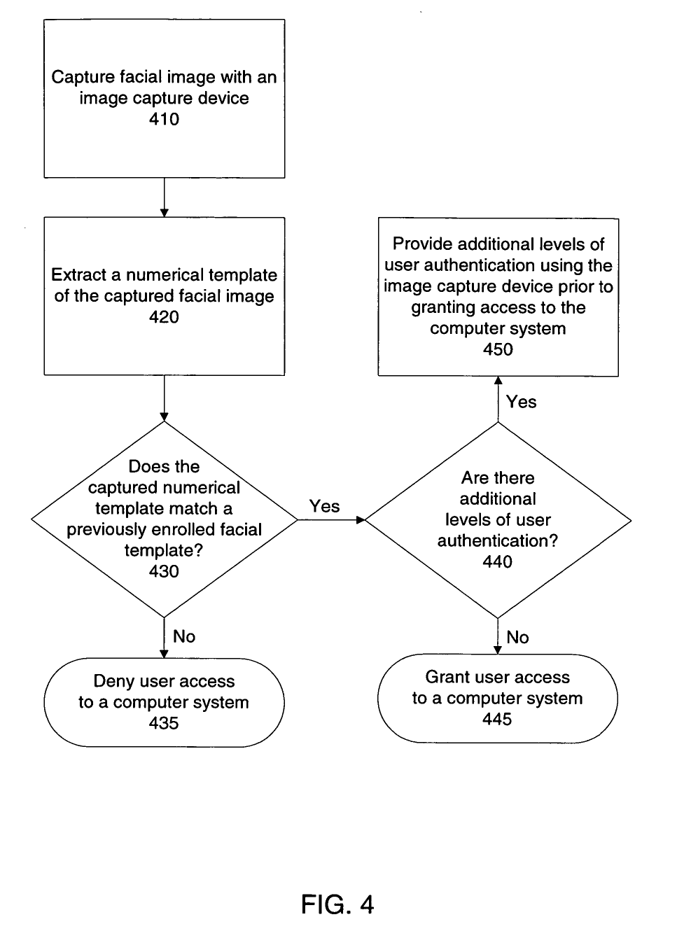

FIG. 4 is a flowchart of an embodiment of an additional level of user authentication. In operation 410, a facial image is captured using the same image capture device that captured the fingerprint image in FIG. 3. A numerical template of the captured facial image is then extracted in operation 420. The numerical template of the captured facial image is then compared with a previously enrolled facial template in operation 430. If the numerical template of the facial image does not match a previously enrolled facial template, the user is denied access to the computer system in operation 435.

If the numerical template of the facial image matches a previously enrolled facial template, the computer system may check for additional levels of user authentication in operation 440. If no additional levels of authentication are required, the user is granted access to the computer system in operation 445. If additional levels of authentication are required, then the image capture device is used to provide additional levels of user authentication in operation 450 prior to granting access to the computer system.

The algorithms for granting user authentication to a computer system as described in FIG. 3 and FIG. 4 may be stored in a memory of the computer system during execution. The algorithms may then later be retrieved from some form of mass storage or non-volatile memory device within the computer system for execution. Alternatively, the user authentication algorithms may be retrieved from non-volatile storage for execution in a memory of an electronic device coupled to the computer system.

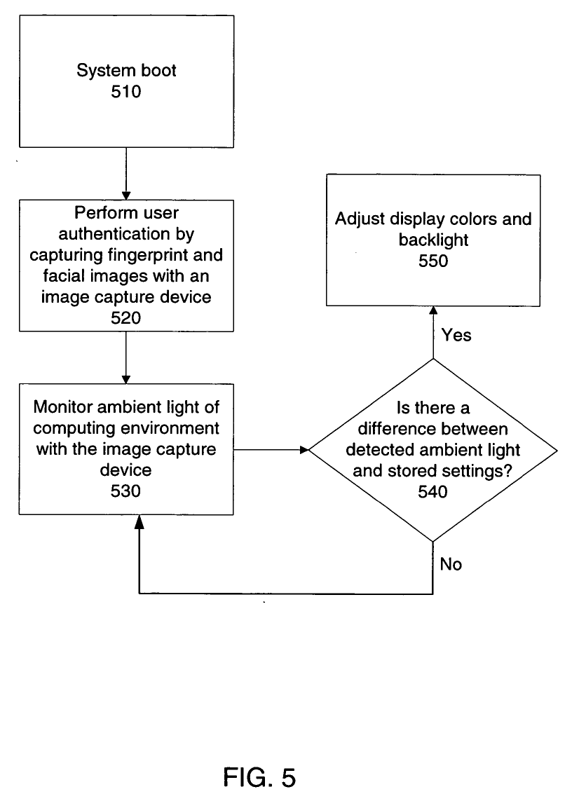

FIG. 5 is a flowchart of an embodiment for using an image capture device to provide user authentication and to monitor ambient lighting of a computing environment. In operation 510, a computer system is booted. A potential user's fingerprint and facial images are then captured with an image capture device in operation 520. The captured images are compared against previously enrolled images to authenticate the user. If matches to the captured images are found, the user is given access to the computer.

After granting user access, the image capture device may be used to monitor ambient light available to the computing environment in operation 530. The detected ambient lighting is compared against saved display settings in operation 540. If there is a difference between the detected ambient lighting and the desired lighting for the computer environment as saved in the display settings, the colors of the computer system display may be adjusted in operation 550. The backlight of the display may also be adjusted in operation 550 to compensate for inadequate lighting.

In the foregoing specification the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense.

1. A computer system, comprising:
a processor; and
an image sensor coupled to the processor to capture a facial image and a fingerprint image, wherein the facial image and the fingerprint image are focused through a lens.

2. The computer system of claim 1, further comprising:
a protective coating coupled to the lens to protect the lens from debris.

3. The computer system of claim 1, further comprising:
a memory coupled to the processor to store previously enrolled facial and fingerprint images.

4. The computer system of claim 3, wherein the processor compares the captured facial and fingerprint images with previously enrolled facial and fingerprint images, wherein the processor grants a user access to the computer system if the captured facial and fingerprint images matches previously enrolled facial and fingerprint images.

5. The computer system of claim 2, further comprising:
an illuminating device coupled to the protective lens to provide light for capturing a fingerprint image.

6. The computer system of claim 5, wherein the illuminating device is enabled when a user makes contact with the protective lens.

7. The computer system of claim 1, wherein the image sensor is a charge-coupled device.

8. The computer system of claim 1, wherein the image sensor is a complementary metal oxide semiconductor.

9. The computer system of claim 2, wherein the protective coating comprises plastic plate.

10. A computer system, comprising:
means for sensing ambient light available to the computer system;
means for capturing a fingerprint image; and
means for capturing a facial image.

11. The computer system of claim 10, further comprising:
means for adjusting colors of a display based on the ambient light sensed.

12. The computer system of claim 10, further comprising:
means for illuminating a finger prior to the fingerprint image being captured.

13. The computer system of claim 10, further comprising:
means for analyzing the fingerprint and facial images captured.

14. The computer system of claim 10, further comprising:
means for focus adjustment between capturing a fingerprint image and capturing a facial image.

15. The computer system of claim 10, further comprising:
means for user authentication to the computer system.

16. The computer system of claim 10, further comprising:
means for placing the computer system to a low power mode if a user presence is not detected.

17. The computer system of claim 10, further comprising:
means for capturing a streaming digital video; and
means for capturing a digital still image.

18. A method, comprising:
capturing a fingerprint image with an image capture device;
adjusting a focus mechanism of the sensor device; and
capturing a facial image with the image capture device.

19. The method of claim 18, further comprising:
generating numerical templates of the captured fingerprint and facial images.

20. The method of claim 19, further comprising:
comparing the captured fingerprint and facial images to previously enrolled fingerprint and facial images; and
granting access to a computer system to a user if the captured fingerprint and facial images matches previously enrolled fingerprint and facial images.

21. The method of claim 18, further comprising:
measuring ambient light of a computing environment with the image capture device.

22. The method of claim 21, further comprising:
adjusting color contrasts of a computer display if the ambient light of the computing environment changes.

23. The method of claim 21, further comprising:
adjusting a backlight of a computer display if the ambient light of the computing environment changes.

24. The method of claim 18, wherein the focus mechanism of the sensor device is adjusted by a mechanical movement of a lens.

25. The method of claim 18, wherein the focus mechanism of the sensor device is adjusted by software.
